(19) United States
(12) Patent Application Publication
(10) Pub. No.: US 2003/0060256 A1
(43) Pub. Date: Mar. 27, 2003

(54) Gaming machine with sweepstakes entry dispenser

(76) Inventor: Shridhar P. Joshi, Skokie, IL (US)

Correspondence Address: Michael J. Blankstein, WMS Gaming Inc., 800 South Northpoint Boulevard, Waukegan, IL, 60085, US

(21) Appl. No.: 09/965,163

(22) Filed: Sep. 27, 2001

(51) Int. Cl. A63F 13/00

(52) U.S. Cl. 463/16

(57) ABSTRACT

A method of conducting a sweepstakes comprises conducting a game on a gaming machine and dispensing a sweepstakes entry from the gaming machine in response to predetermined criteria. The sweepstakes entry is filled out by the player and submitted to a sweepstakes provider for a subsequent drawing. The predetermined criteria for dispensing the sweepstakes entry from the gaming machine may, for example, include a game outcome associated with a payout exceeding a predetermined threshold.

### FIELD OF THE INVENTION

The present invention relates generally to gaming machines and, more particularly, to a gaming machine for dispensing a sweepstakes entry in response to predetermined criteria.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available because such machines attract frequent play and hence increase profitability to the operator.

### SUMMARY OF THE INVENTION

A method of conducting a sweepstakes comprises conducting a game on a gaming machine and dispensing a sweepstakes entry from the gaming machine in response to predetermined criteria. The sweepstakes entry is filled out by the player and submitted to a sweepstakes provider for a subsequent drawing. The predetermined criteria for dispensing the sweepstakes entry from the gaming machine may, for example, include a game outcome associated with a payout exceeding a predetermined threshold.

### BRIEF DESCRIPTION OF THE DRAWINGS

The foregoing and other advantages of the invention will become apparent upon reading the following detailed description and upon reference to the drawings.

FIG. 1 is an isometric view of a gaming machine including a dispenser for dispensing a sweepstakes entry in accordance with the present invention.

FIG. 2 is a display screen capture of a slot game that may be played on the gaming machine.

FIG. 3 is a top view of the sweepstakes entry.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

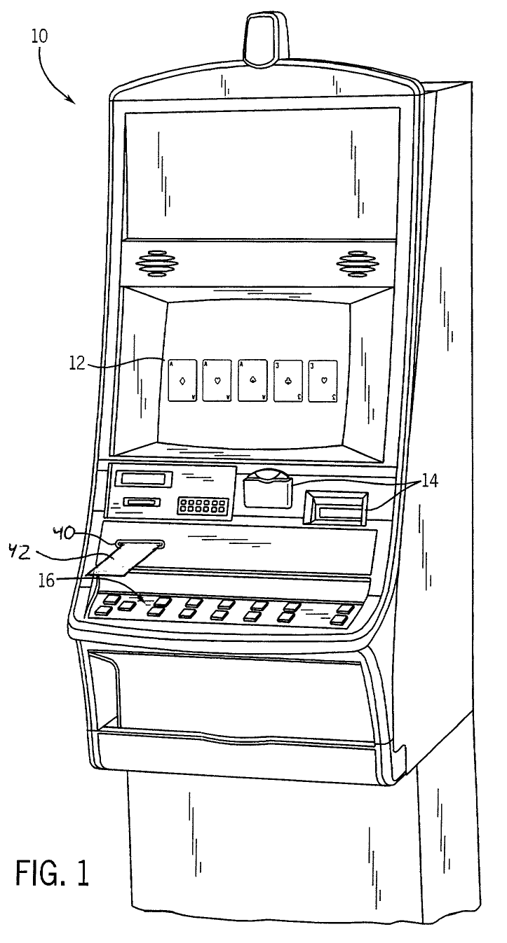

Turning now to the drawings, FIG. 1 depicts an isometric view of a gaming machine 10 controlled by a processor in response to a wager. The gaming machine 10 includes a visual display 12 preferably in the form of a dot matrix, CRT, LED, LCD, electro-luminescent, or other type of video display known in the art. If the display 12 is a video display, the display 12 is preferably overlaid with a touch screen. In the illustrated embodiment, the gaming machine 10 is an “upright” version in which the display 12 is oriented vertically relative to the player. Alternatively, the gaming machine may be a “slant-top” version in which the display 12 is slanted at about a thirty-degree angle toward the player of the gaming machine 10.

The gaming machine 10 includes a plurality of possible credit receiving mechanisms 14 for receiving credits to be used for placing wagers in the game. The credit receiving mechanisms 14 include, for example, a coin acceptor, a bill acceptor, a ticket acceptor, and a card reader. The bill and ticket acceptors may be combined into a single unit. The card reader may, for example, accept magnetic cards and smart (chip) cards. If the gaming machine 10 stands alone and is not linked to a central system, the tickets and cards are preferably coded with a credit amount. Upon insertion of such a ticket or card into the gaming machine 10, this credit amount is added to the machine's credit meter. If, however, the gaming machine 10 is linked to a central accounting database, the tickets and cards may merely identify a player's account. Upon insertion of such a ticket or card into the machine 10, the credit amount in the player's account is downloaded from the accounting database to the machine 10.

The gaming machine 10 includes a plurality of pushbuttons 16 for placing wagers and initiating a play of the game. These pushbuttons may, for example, include a bet-one credit pushbutton, a bet-maximum credit pushbutton, and a deal or spin-reels pushbutton depending upon the nature of the game. Corresponding soft touch keys are preferably depicted on the display 12 so that the player can place a wager and initiate a play using either the soft touch keys or the pushbuttons.

In response to receiving a wager and a command to initiate play, the central processing unit (CPU) of the gaming machine 10 randomly selects a game outcome from a plurality of possible outcomes for the game being executed on the gaming machine. The game is preferably selected from a group consisting of poker, slots, keno, bingo, and blackjack. The CPU causes the display 12 to depict a plurality of symbol-bearing indicia representative of the selected game outcome. In the case of draw poker, the plurality of symbol-bearing indicia include five playing cards from a deck of 52 cards. The cards are shown with their numbers and suits revealed. In the case of slots, the plurality of symbol-bearing indicia include mechanical or simulated slot reels that are rotated and stopped to place symbols on the reels in visual association with one or more pay lines. If the slot reels are mechanical, the reels are primarily contained with the machine housing but project through respective slots in a front side of the housing. The display 12 includes a transparent window through which the mechanical slot reels may be viewed.

After the plurality of symbol-bearing indicia are displayed, the game may require a degree of player interaction in which the player selects one or more game play elements that influence an outcome of the play. In the case of draw poker, for example, the player may select which of the playing cards to hold and which of the playing cards to discard. In the case of slots, for example, the slot game may be a hold-and-respin game that permits the player to hold the results of one or more reels and spin the remaining reels a second time in an attempt to improve the result. To select which cards or reels to hold and which cards or reels to “discard,” the plurality of pushbuttons 16 may include hold/discard pushbuttons for holding or discarding corresponding ones of the cards or reels. Corresponding soft touch keys are preferably depicted on the display 12 if it is a video display.

In response to the player's selection, the CPU randomly selects a game outcome from a plurality of possible outcomes for a final stage of the game being executed on the gaming machine. The CPU causes the display 12 to depict symbol-bearing indicia representative of the selected final game outcome. In the case of draw poker, the held cards remain on the display 12 while the discarded cards are replaced with new cards randomly selected from remaining cards in the deck. The new cards are shown with numbers and suits revealed. In the case of slots, the held reels continue to show the same respective symbols on the display 12 while the “discarded” reels are respun and stopped to place the same or different symbols on the respun reels in visual association with the one or more pay lines.

System memory stores control software, operational instructions and data associated with the gaming machine 10. In one embodiment, the memory comprises a separate read-only memory (ROM) and battery-backed random-access memory (RAM). However, it will be appreciated that the system memory may be implemented on any of several alternative types of memory structures or may be implemented on a single memory structure. The system memory contains a math table identifying, among other things, the plurality of possible game outcomes, a number of expected occurrences (hits) of each outcome in a total cycle, a payout for each outcome, a probability of hitting each outcome, and an expected value for each outcome. Each payout corresponds to a certain credit amount. If the game outcome is associated with a payout and is therefore considered a “winning” outcome, the CPU adds the credit amount for that payout to the machine's credit meter.

Instead of or in addition to a payout, the game outcome may trigger a bonus game that allows the player to win additional money through an activity other than the main card or slot game. An example of such a bonus game is a gamble feature that presents a plurality of player-selectable strategy options to a player for selection. The player selects one of the strategy options to generate a first bonus amount. The player then has the option of keeping the first bonus amount or returning it in favor of selecting a different strategy option associated with a second bonus amount. This process of permitting the player to gamble by returning a bonus amount in an attempt to improve the result may be repeated a predetermined number of times.

After the current play is completed, the player may discontinue play and cash out by pressing a “collect” pushbutton or soft touch key. Alternatively, the player may place another wager and initiate another play of the game as described above. As noted above, the game of chance may be interactive in that, after the plurality of symbol-bearing indicia are initially displayed during the play, the game prompts the player to make at least one selection (either in the main game or the bonus game) that influences an outcome of the game.

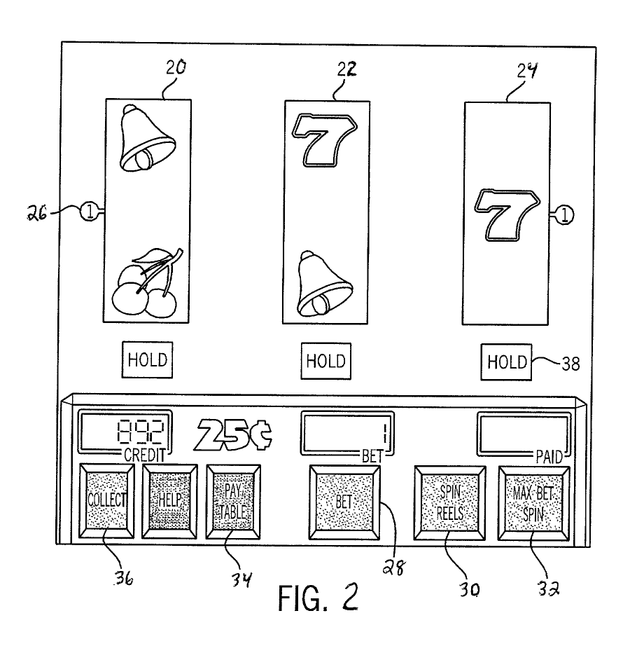

In one embodiment of the hold-and-respin slot game shown in greater detail in FIG. 2, the slot game includes three reels 20, 22, and 24 and a single horizontal pay line 26 passing through the middle symbol on each reel. Although the reels are illustrated as being simulated on a video display, the reels may alternatively be mechanical and driven by stepper motors.

Generally, a player initiates game play by inserting a number of coins or by selecting a number of credits to wager using the “Bet” key 28. The reels may then be set in motion by touching the “Spin Reels” key 30 or, if the player wishes to wager the maximum amount, by using the “Max Bet Spin” key 32. Alternatively, other mechanisms such as, for example, a lever or push button may be used to set the reels in motion. The CPU uses a random number generator to select a game outcome corresponding to a particular set of reel “stop positions.” The CPU then causes each of the reels to stop at the appropriate stop position. Symbols are displayed on the reels to graphically illustrate the reel stop positions and indicate whether the stop positions of the reels represent a winning game outcome.

After the reels 20, 22, and 24 are spun and stopped once, the game permits the player to hold the results of one or more reels and spin the remaining reels a second time in an attempt to improve the result. To select which reels to hold and which reels to re-spin, the plurality of pushbuttons 16 may include hold/discard pushbuttons for holding or re-spinning corresponding ones of the reels. Corresponding soft touch keys 38 are preferably depicted on the display 12 if it is a video display.

Winning outcomes (e.g., symbol combinations resulting in payment of coins or credits) are identifiable to the player by a pay table. In one embodiment, the pay table is affixed to the machine and/or displayed by the video display in response to a command by the player (e.g., by pressing the “Pay Table” button 34). A winning outcome occurs when the symbols appearing on the reels 20, 22, and 24 along the pay line 26 correspond to one of the winning combinations on the pay table. If the displayed symbols stop in a winning combination (after any non-held reels have been re-spun), the game credits the player an amount corresponding to the award in the pay table for that combination multiplied by the number of credits bet. The player may collect the amount of accumulated credits by pressing the “Collect” button 36.

Referring back to FIG. 1, in accordance with the present invention the gaming machine 10 includes a dispenser 40 for dispensing a sweepstakes entry 42 in response to a predetermined triggering event. The triggering event may be based on the game outcome, a number of plays of the game, frequency of play, amount of wager, number of activated pay lines in a slot game, player tracking information, time of day, or some other criteria.

With respect to basing the triggering event on the game outcome, the dispenser 40 may dispense the sweepstakes entry 42 in response to a game outcome associated with a payout exceeding a predetermined threshold. For example, any game outcomes associated with a payout of at least 50 credits may cause the dispenser 40 to dispense the sweepstakes entry 42. Alternatively, the dispenser 40 may dispense the sweepstakes entry 42 in response to a game outcome associated with a payout below a predetermined threshold. For example, any game outcomes associated with a payout less than 50 credits may cause the dispenser 40 to dispense the sweepstakes entry 42. In another embodiment, the dispenser 40 may dispense the sweepstakes entry 42 in response to one or more particular game outcomes that effectively include the sweepstakes entry 42 as part of the payout. For example, if the game is a three-reel, one-line slot game and one of the reel symbols is a sweepstakes symbol, the dispenser 40 may dispense the sweepstakes entry 42 in response to a predetermined number of sweepstakes symbols appearing on the pay line.

With respect to basing the triggering event on a number of plays of the game, the dispenser 40 may dispense the sweepstakes entry 42 after every N number of plays where N is a predetermined integer such as 5, 10, 15, etc. A play may be defined as a single wager and an associated outcome.

With respect to basing the triggering event on a frequency of play, the dispenser 40 may dispense the sweepstakes entry 42 if the gaming machine executes N number of plays over a certain period of time. For example, playing the machine at least ten times within five minutes may cause the dispenser 40 to dispense the sweepstakes entry 42.

With respect to basing the triggering event on an amount of wager and/or a number of activated pay lines in a slot game, the dispenser 40 may dispense the sweepstakes entry 42 in response to the player's wager exceeding a predetermined threshold. For example, in a slot game the dispenser 40 may dispense the sweepstakes entry 42 in response to a maximum wager on all available pay lines.

With respect to basing the triggering event on player tracking information, the gaming machine 10 may be outfitted with a player tracking module linked to a remote host computer. The host computer includes a player tracking database with a plurality of records. The player tracking module includes a card reader for accepting a player tracking card held by a player. The player tracking card includes an account identifier associated with the player's record in the player tracking database. The player's record includes player tracking information such as personal identification information, demographic data, and game play data as disclosed in U.S. Pat. No. 5,179,517 to Sarbin et al., which is incorporated herein by reference in its entirety. The game play data may include an identification of last ten machines played, specific information relating to the games played, and the jackpots and other prizes won by the player. For each denomination (e.g., nickel, dime, quarter, half-dollar, dollar, etc.), the game play data may include data fields for the number of coins played, the number of coins paid out, the number of games played, the number of coins paid by attendants, and the time of play in minutes. Of course, the amount and types of data in the player's record may be varied to suit a particular casino operating environment. Based on the player tracking information in the player's record, the host computer performs calculations to compute bonuses to be awarded to the player when playing the gaming machine 10. One of these bonuses may be a sweepstakes entry 42 dispensed by the dispenser 40.

With respect to basing the triggering event on the time of day, the dispenser 40 may dispense the sweepstakes entry 42 at predetermined time intervals (e.g., every 15 minutes) and/or at predetermined times on a clock (e.g., at the top of the hour). In one embodiment the dispenser 40 only dispenses the sweepstakes entry 42 while the gaming machine 10 is being played, while in another embodiment the dispenser 40 dispenses the sweepstakes entry 42 regardless of whether the gaming machine 10 is being played.

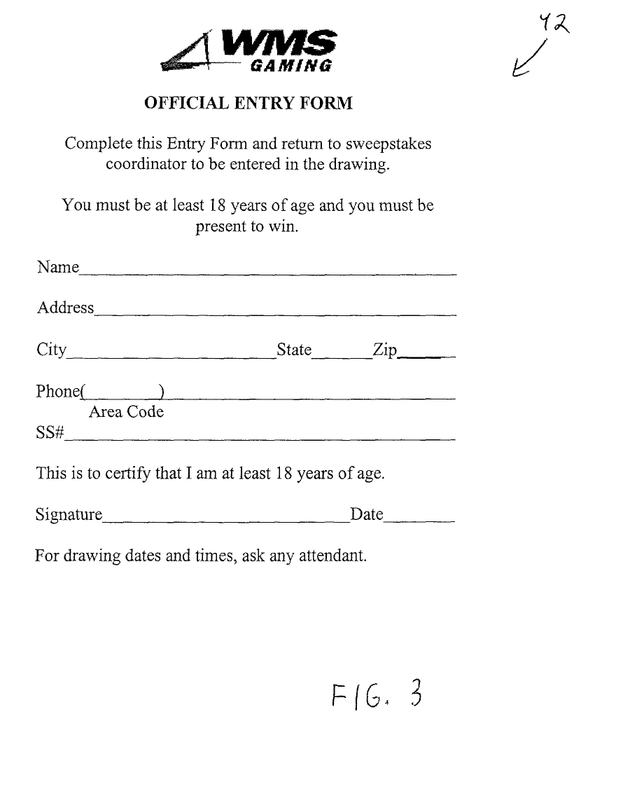

The sweepstakes entry 42 includes a pre-printed paper entry form to be filled out by the player. The entry form may be shaped in the form of a coupon or currency bill and may appear generally as shown in FIG. 3. After filling out the entry form, the player may submit it to the sweepstakes provider that will conduct a subsequent drawing to determine a winner(s) of one or more prizes associated with the sweepstakes. The sweepstakes provider may, for example, be the gaming establishment itself, the gaming machine supplier, or an unaffiliated entity. Depending upon the sweepstakes provider, the player may submit the sweepstakes entry 42 to the sweepstakes provider at the gaming establishment itself (e.g., by dropping the entry into a drop box or handing it to an attendant), by mail, or possibly via the Internet. To allow the player to submit the sweepstakes entry 42 via the Internet, the sweepstakes entry 42 may identify a web site and a security access code to be entered on the web site. When the access code is entered on the web site, the web site may prompt the player to fill out an electronic sweepstakes entry form.

The drawing to determine the sweepstakes winner(s) may be conducted at any desired time interval, such as daily, weekly, monthly, etc., and at any desired time. The prize(s) associated with the sweepstakes may be cash, goods, and/or services. As is typical of sweepstakes, the prize(s) may include a grand prize, some top level prizes, and then numerous consolation prizes.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method of conducting a sweepstakes, comprising:
conducting a game on a gaming machine; and
dispensing a sweepstakes entry from the gaming machine in response to predetermined criteria.

2. The method of claim 1, wherein the step of conducting a game includes selecting an outcome from a plurality of possible outcomes, and wherein the predetermined criteria includes the selected outcome being a predetermined one or more of the plurality of possible outcomes.

3. The method of claim 2, wherein the predetermined one or more of the plurality of possible outcomes are associated with a payout exceeding a predetermined threshold.

4. The method of claim 1, wherein the step of conducting a game includes selecting an outcome from a plurality of possible outcomes, and wherein the predetermined criteria includes the selected outcome being associated with a payout exceeding a predetermined threshold.

5. The method of claim 1, wherein the step of dispensing a sweepstakes entry occurs in response to a predetermined outcome selected in the game.

6. The method of claim 1, wherein the sweepstakes entry includes a paper entry form.

7. The method of claim 6, wherein the paper entry form is pre-printed.

8. The method of claim 1, further including receiving the sweepstakes entry after the sweepstakes entry has been filled out by a player.

9. The method of claim 8, wherein the sweepstakes entry is received in a drop box at a gaming establishment where the gaming machine is located.

10. The method of claim 8, wherein the sweepstakes entry is received by mail.

11. The method of claim 8, wherein the sweepstakes entry is received by an attendant at a gaming establishment where the gaming machine is located.

12. The method of claim 1, wherein the step of conducting a game includes receiving a wager from a player to initiate play of the game on the gaming machine, and randomly selecting an outcome from a plurality of possible outcomes.

13. The method of claim 12, wherein the game is selected from a group consisting of slots, poker, keno, bingo, and blackjack.

14. A method of conducting a sweepstakes, comprising:
receiving a wager to initiate play of a game on a gaming machine;
randomly selecting an outcome for the game from a plurality of possible outcomes;
representing the selected game outcome on a visual display; and
dispensing a sweepstakes entry from the gaming machine in response to predetermined criteria.

15. The method of claim 14, wherein the predetermined criteria includes the selected game outcome being a predetermined one or more of the plurality of possible outcomes.

16. The method of claim 15, wherein the predetermined one or more of the plurality of possible outcomes are associated with a payout exceeding a predetermined threshold.

17. The method of claim 14, wherein the sweepstakes entry includes a paper entry form.

18. A gaming machine, comprising:
means for conducting a game; and
a dispenser for dispensing a sweepstakes entry in response to predetermined criteria.

19. The gaming machine of claim 18, wherein the conducting means selects an outcome from a plurality of possible outcomes, and wherein the predetermined criteria includes the selected outcome being a predetermined one or more of the plurality of possible outcomes.

20. The gaming machine of claim 19, wherein the predetermined one or more of the plurality of possible outcomes are associated with a payout exceeding a predetermined threshold.

21. The gaming machine of claim 18, wherein the conducting means selects an outcome from a plurality of possible outcomes, and wherein the predetermined criteria includes the selected outcome being associated with a payout exceeding a predetermined threshold.

22. The gaming machine of claim 18, wherein the dispenser dispenses the sweepstakes entry in response to a predetermined outcome selected by the conducting means.

23. The gaming machine of claim 18, wherein the sweepstakes entry includes a paper entry form.

24. The gaming machine of claim 23, wherein the paper entry form is pre-printed.

25. The gaming machine of claim 18, wherein the conducting means receives a wager from a player to initiate play of the game on the gaming machine, and randomly selects an outcome from a plurality of possible outcomes.

26. The gaming machine of claim 25, wherein the game is selected from a group consisting of slots, poker, keno, bingo, and blackjack.
